(19) United States
(12) Patent Application Publication
(10) Pub. No.: US 2026/0243594 A1
(43) Pub. Date: Aug. 20, 2026

(54) SYSTEMS AND METHODS FOR PADDY FARM WATER LEVEL MEASUREMENT

(71) Applicants: Climate Sense, Inc., Charlotte, NC (US); NeoAura Technologies Private Limited, Somajiguda (IN)

(72) Inventors: Kevin Taylor Cyle, Atlanta, GA (US); Gandura O. Abagandura, Fridley, MN (US); Alex Morgan, Winthrop, WA (US); Nishitha Reddy Lankireddy, Hyderabad (IN); Neelesh Reddy Lankireddy, Hyderabad (IN); Suman Bharti, Gaya (IN)

(21) Appl. No.: 19/541,925

(22) Filed: Feb. 17, 2026

Related U.S. Application Data
(60) Provisional application No. 63/930,890, filed on Dec. 4, 2025.

(30) Foreign Application Priority Data
Feb. 18, 2025 (IN) 202521013949

(51) Int. Cl. G01F 23/2962

(52) U.S. Cl. CPC G01F 23/2962

(57) ABSTRACT

A portable ultrasonic measurement system for measuring water levels is disclosed. The system includes a coupling portion that extends from a body and defines a cavity configured to receive a top portion of a water level tube. An ultrasonic sensor coupled to the coupling portion transmits ultrasonic signals toward a water surface within the water level tube and receives reflected signals from the water surface. A controller calculates a water level within the water level tube based on a time of flight of the ultrasonic signals and the reflected signals. A GPS module obtains geographic coordinates associated with the water level measurements, enabling spatial mapping of measurements across agricultural fields.

### CROSS-REFERENCE TO RELATED APPLICATIONS

This application claims priority to Indian Patent Application 202521013949 filed on February 18, 2025, and claims the benefit of U.S. Patent Application No.: 63/930,890 filed on December 4, 2025, the disclosures of which are each incorporated herein by reference in their entirety.

### BACKGROUND

The cultivation of rice stands as one of humanity's most essential agricultural practices, with proper water management playing a critical role in ensuring optimal crop yields. Traditional methods of measuring water levels in paddy fields have historically relied upon visual observation techniques, with the Bowman-tube method being employed across rice-growing regions. This method involves inserting a transparent tube into the soil and manually observing the water level against measurement markings. While the Bowmen-tube has served as a fundamental tool for generations of farmers, it presents several significant limitations in modern agricultural contexts. The manual nature of these observations introduces substantial potential for human error, particularly under varying lighting conditions or when multiple readings are required across large cultivation areas. The labor-intensive nature of this approach also places considerable demands on farming operations, requiring frequent field visits to maintain proper water management protocols.

The environmental impact of conventional paddy field management practices has also become increasingly concerning in recent years. Continuous flooding, while traditional, has been recognized as a significant contributor to excessive water consumption in agricultural systems. Furthermore, this practice has been identified as a source of greenhouse gas emissions, particularly methane, thereby contributing to global climate change. These environmental considerations have prompted the agricultural community to seek more sustainable approaches to rice cultivation, such as the Alternate Wetting and Drying (AWD) method. However, the successful implementation of AWD and similar water-efficient practices requires precise and reliable water level monitoring capabilities that exceed the limitations of traditional measurement techniques.

While various water level measurement devices exist, there remains a need for an integrated system that combines accurate measurement capabilities with features that support modern sustainable farming practices.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a block diagram of an example portable ultrasonic measurement system in accordance with one non-limiting embodiment.

FIG. 2 depicts an example portable ultrasonic measurement system in accordance with a non-limiting embodiment.

FIG. 3 depicts a bottom view of the portable ultrasonic measurement system shown in FIG. 2.

FIGS. 4-5 depict a water level measurement process using an example portable ultrasonic measurement system in accordance with one non-limiting embodiment.

FIG. 6 schematically depicts a water level measurement process in accordance with one non-limiting embodiment.

FIG. 7 depicts an example use of a portable ultrasonic measurement system in the field in accordance with one non-limiting embodiment.

### DETAILED DESCRIPTION

Various non-limiting embodiments of the present disclosure will now be described to provide an overall understanding of the principles of the structure, function, and use of the systems and methods as disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to "various embodiments," "some embodiments," "one embodiment," "some example embodiments," "one example embodiment," or "an embodiment" means that a particular feature, structure, or characteristic described in connection with any embodiment is included in at least one embodiment. Thus, appearances of the phrases "in various embodiments," "in some embodiments," "in one embodiment," "some example embodiments," "one example embodiment," or "in an embodiment" in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Components and modules can be implemented in software, hardware, or a combination of software and hardware. The term software is used expansively to include not only executable code, but also data structures, data stores, and computing instructions in any electronic format, firmware, and embedded software. The terms information and data are used expansively and can include a wide variety of electronic information, including but not limited to machine-executable or machine-interpretable instructions; content such as text, video data, and audio data, among others; and various codes or flags. The terms information, data, and content are sometimes used interchangeably when permitted by context.

The examples discussed herein are examples only and are provided to assist in the explanation of the systems and methods described herein. None of the features or components shown in the drawings or discussed below should be taken as mandatory for any specific implementation of any of these systems and methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

In accordance with the present disclosure, example embodiments of a portable measurement system are provided that are specifically configured to measure water levels in paddy fields. As described in more detail below, these handheld portable systems can utilize ultrasonic waves and traditional water level tubes, such as Bowman tubes, to accurately measure, monitor, and manage water levels for optimal rice crop growth, for example. The portable system can include an ultrasonic sensor that is configured to emit pressure waves down a water level tube, which is partially inserted into the soil and is at least partially filled with water. When the pressure waves hit the water surface, they are reflected back to the sensor. By calculating the time it takes for the pressure waves to travel to the water surface and return, and based on the known height of the tube, the system can determine the water level inside the water level tube.

In accordance with various embodiments, the handheld system can be equipped with a rechargeable battery, making it portable and convenient for use across multiple locations in a paddy field. Further, each water level reading can be tagged with GPS coordinates and a timestamp, ensuring that the data collected is authentic, precise, and tamper-proof. The data can be wirelessly transferred to a remote server for further analysis and monitoring, as well as integration into other technologies, which can aid in better irrigation management, among other benefits.

In some embodiments, software that is local to a portable measurement system processes the ultrasonic signals, calculates the time of flight, and converts it into a readable water level measurement. Such software can also interface with an on-board GPS module to associate location data and timestamps with the water level measurement. Such data can be stored in the system's memory for later retrieval and/or provided to a remote server via wireless network connectivity. Thus, the portable ultrasonic measurement systems in accordance with the present disclosure can provide accurate and reliable water level measurements, helping farmers optimize their irrigation practices, conserve water, and ultimately improve crop yields. More specifically, farmers can manage irrigation more effectively, reduce water waste, and minimize carbon emissions by supporting sustainable cultivation practices.

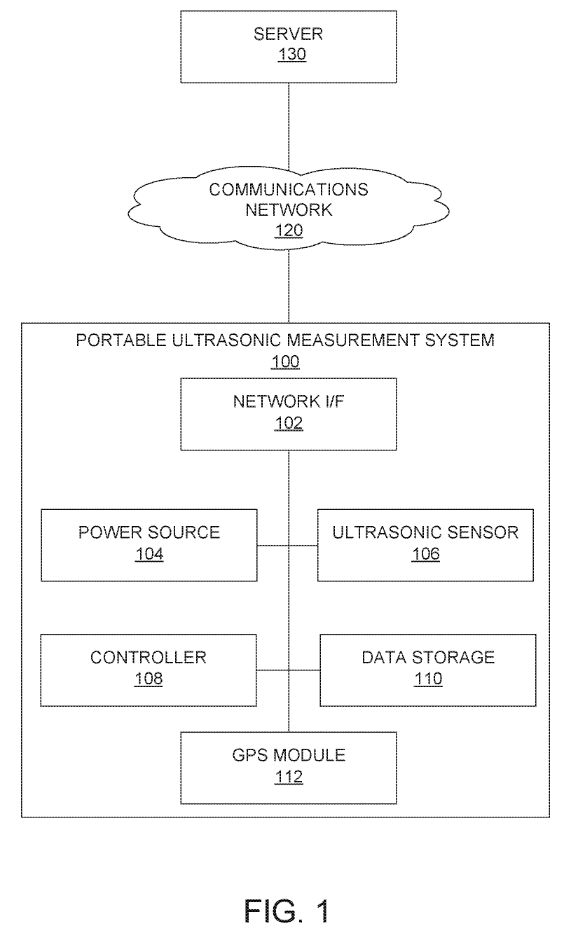

Referring now to FIG. 1, a block diagram of an example portable ultrasonic measurement system 100 is depicted. The portable ultrasonic measurement system 100 can include a controller 108, data storage 110, and a power source 104. The controller 108 can be a microcontroller or microprocessor configured to execute instructions stored in the data storage 110 to control operation of the system 100. The data storage 110 can include volatile memory, such as RAM, and non-volatile memory, such as flash memory or EEPROM, for storing measurement data, configuration settings, and operational parameters. The power source 104 can be any suitable power source, such as a rechargeable lithium-ion battery or a replaceable battery pack capable of providing stable voltage levels required for accurate measurements.

The portable ultrasonic measurement system 100 can include an ultrasonic sensor 106 comprising a transmitter and receiver. The transmitter generates high-frequency sound waves, typically at 40 kHz, while the receiver detects waves reflected off a water surface when the system is positioned on a water level tube. The controller 108 can calculate water level based on the time between transmission and reception of the reflected waves.

In some embodiments, the portable ultrasonic measurement system 100 can include a GPS module 112 for associating geographic coordinates with water level measurements, enabling spatial mapping of measurements across a field or multiple fields. The GPS module 112 can provide location data with accuracy suitable for agricultural applications, typically within 2-3 meters, for example. The water level measurements, timestamps, and associated GPS coordinates can be stored locally in the data storage 110 for subsequent retrieval and analysis.

In some embodiments, measurement data can be wirelessly transmitted to a remote server 130 via network interface 102 through a communications network 120. The network interface 102 can include cellular connectivity (e.g., 4G LTE, 5G), Wi-Fi, or other wireless protocols suitable for agricultural environments. Additionally, or alternatively, the water level measurements can be transmitted to a computing device through other types of suitable network connections, such as a USB connection for direct data transfer, or using a BLUETOOTH communication protocol for short-range wireless connectivity to mobile devices or tablets. The remote server 130 can aggregate data from multiple measurement systems to provide comprehensive field monitoring capabilities.

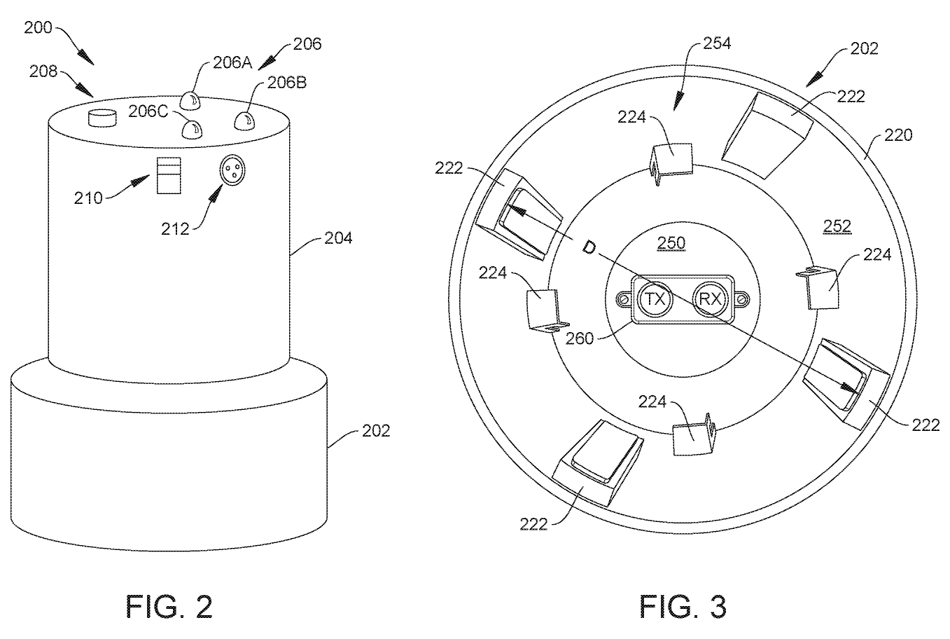

FIG. 2 depicts an example portable ultrasonic measurement system 200 in accordance with a non-limiting embodiment. FIG. 3 depicts a bottom view of the portable ultrasonic measurement system 200 shown in FIG. 2. Referring to FIGS. 2-3, the portable ultrasonic measurement system 200 can include a body 204, with a coupling portion 202 extending from the body 204. The body 204, which can be constructed from impact-resistant and weatherproof materials such as ABS plastic or polycarbonate, houses various components of the portable ultrasonic measurement system 200 in a weatherproof enclosure, including various components illustrated in FIG. 1. The enclosure provides protection against water ingress with an IP67 rating or higher, enabling operation in agricultural environments.

The portable ultrasonic measurement system 200 can include multiple output indicators 206 for conveying operational status and system conditions to an operator. While FIG. 2 depicts LED output indicators 206A-C, where indicator 206A can display power status, indicator 206B can show network status, and indicator 206C can indicate sampling status, this disclosure is not so limited. It is to be appreciated that any suitable type of output indicator 206 can be used, such as an LCD screen for displaying numerical measurements, auditory indicators for providing feedback in bright outdoor conditions, or haptic feedback mechanisms, among others.

The portable ultrasonic measurement system 200 includes an input device 208, illustrated as a sealed membrane button in FIG. 2. Such input device 208 can be engaged by an operator to initiate a water level measurement process, configure system settings, or trigger data transmission. It is to be appreciated that while a single button is illustrated in FIG. 2, this disclosure is not so limited, as a variety of input devices 208 can be used, including capacitive touch sensors, multiple buttons for different functions, or a keypad for entering numerical data.

As shown in FIG. 2, the portable ultrasonic measurement system 200 also includes a waterproof power switch 210 for system activation and a sealed charge port 212, which can be protected by a removable cover. The charge port 212 can accommodate various charging interfaces such as USB-C or proprietary connectors and can also serve as a data transfer port when connected to external computing devices, for example. The power switch 210 can be a sealed toggle or rotary switch designed to prevent accidental activation while maintaining the weatherproof integrity of the enclosure.

Referring now to FIG. 3, a bottom view of the coupling portion 202 is shown. The coupling portion 202 includes a rigid wall 220, fabricated from durable weatherproof material such as ABS plastic or PVC, which defines a cavity 254 for receiving the top portion of a water level tube. The rigid wall 220 is designed with sufficient thickness and structural integrity to maintain alignment during repeated coupling operations.

In some embodiments, as shown in FIG. 3, a plurality of spacer blocks 222 are coupled to an inner surface 252 of the rigid wall 220. The spacer blocks 222, which can be integrally formed with the rigid wall 220 or separately attached using waterproof adhesive or mechanical fasteners, assist in centering the water level tube relative to the portable ultrasonic measurement system 200 to ensure proper readings. The spacing between opposing spacer blocks 222 (shown as D) can be about 4 inches, which coincides with the outer diameter of a standard water level tube. The spacer blocks 222 can include beveled or rounded edges to facilitate smooth engagement with the water level tube during coupling.

The coupling portion 202 can also include a plurality of tube stops 224 that extend outward from the inner surface 252 of the rigid wall 220. The tube stops 224, which can be molded protrusions or adjustable components, are positioned to engage with a top surface of the water level tube when the portable ultrasonic measurement system 200 is lowered onto a water level tube. The tube stops 224 are precisely positioned to provide a known distance between the top of the water level tube and an ultrasonic sensor 260.

As shown, the ultrasonic sensor 260 is coupled to a top wall 250 of the coupling portion 202 and includes a transmitter and receiver. The sensor 260 can be sealed with a waterproof gasket to prevent moisture ingress. The transmitter can generate ultrasonic waves at frequencies typically between 40-50 kHz, while the receiver detects reflected waves for precise distance measurement. The top wall 250 is designed to maintain parallel alignment with the water surface to ensure accurate measurements.

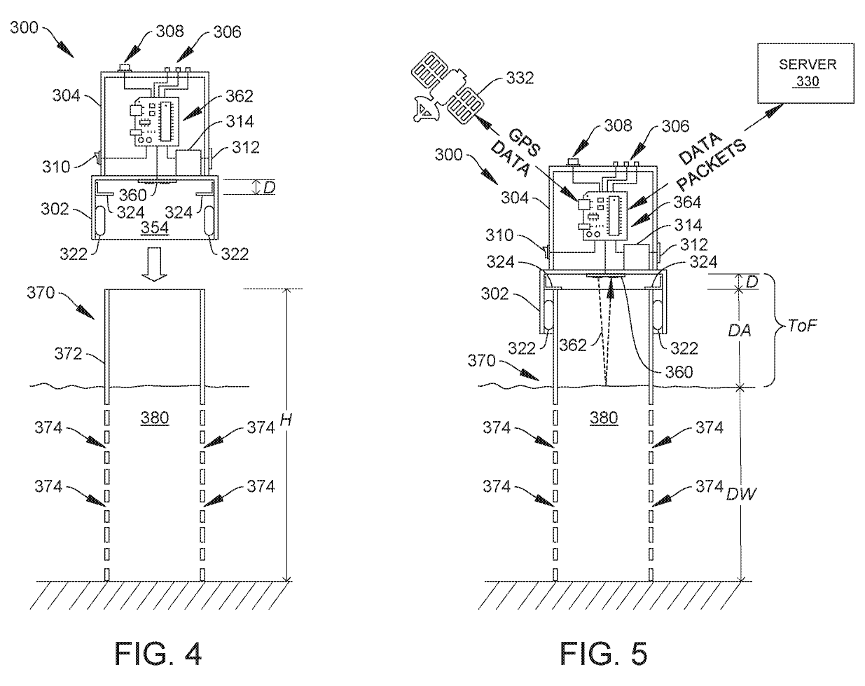

Referring now to FIGS. 4-5, a water level measurement process using an example portable ultrasonic measurement system 300 is shown. A simplified cross-sectional view of the portable ultrasonic measurement system 300 is provided for illustration purposes. Referring first to FIG. 4, a water level tube 370 is shown positioned in water 380. The water level tube 370 has a known height (shown as H), which is typically 30 centimeters. The water level tube 370 is constructed of a circular wall 372 that defines a number of openings 374 spaced along its length that allow water 380 to flow in and out of the tube. These openings 374 are generally sized and positioned to prevent sediment infiltration while maintaining hydraulic connection with the surrounding water.

The portable ultrasonic measurement system 300 includes a body 304, with a coupling portion 302 extending from the body. The coupling portion 302 defines a cavity 354 that receives the top portion of a water level tube. The portable ultrasonic measurement system 300 includes multiple output indicators 306, such as LEDs or LCD displays, for conveying battery level, measurement status, and data transmission status to an operator, for example. The portable ultrasonic measurement system 300 includes an input device 308 designed to withstand repeated use in wet environments. As shown in FIG. 4, the portable ultrasonic measurement system 300 also includes a weatherproof power switch 310 for system activation and a sealed charge port 312, which can be used to charge a power supply 314 such as a lithium-ion battery. A control system 364, which can include a microprocessor, memory, and associated circuitry as illustrated in FIG. 1, is positioned within the body 304. The coupling portion 302 can include spacer blocks 322 and tube stops 324 that collectively align the water level tube 370 with the portable ultrasonic measurement system 300 during the water level measurement process. The distance of the tube stops 324 to an ultrasonic sensor 360 (shown as D) is known and used in the Time of Flight (ToF) calculations.

Referring now to FIG. 5, a water level measurement process is schematically depicted. With the portable ultrasonic measurement system 300 properly positioned on the top of the water level tube 370, the ultrasonic sensor 360 can transmit ultrasonic pulses at frequencies between 40-50 kHz and receive reflected signals 362. As shown, the signals reflect off the top surface of the water 380 within the water level tube. Through ToF calculations, and the known distance D, the control system 364 can determine the distance from the top of the water level tube to the water surface (shown as DA). This distance can be subtracted from the known height of the water level tube (H) to determine the depth of the water 380 (shown as DW).

Further, the control system 364 can include a GPS module for receiving GPS data from a GPS system 332, enabling each water level measurement to be tagged with its geographic coordinates. Such water level data can be provided to a server 330 via any of a variety of suitable data transmission techniques, including real-time transmission through cellular networks, periodic batch transmission via Wi-Fi connections, or manual data transfer through USB interfaces, among others. The transmitted data can include, for example, water level information, measurement timestamps, GPS coordinates.

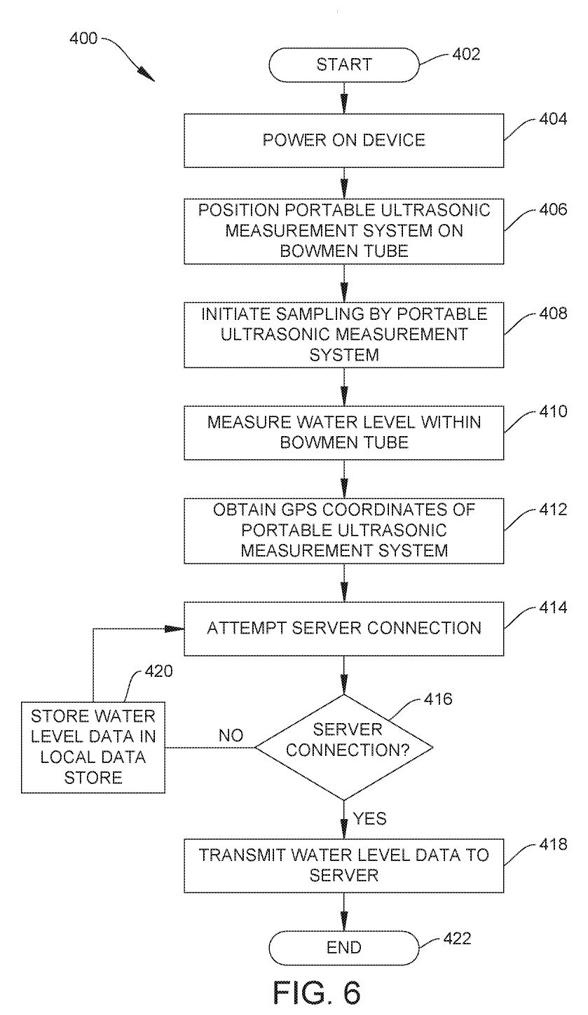

FIG. 6 schematically depicts a water level measurement process 400 in accordance with one non-limiting embodiment. The process starts at 402 with system initialization. At 404, the portable ultrasonic measurement system is powered on, during which the system can perform self-diagnostics to verify proper operation of components including the ultrasonic sensor, GPS module, and power supply.

At 406, the portable ultrasonic measurement system is positioned on top of a water level tube. As provided above, the portable ultrasonic measurement system can incorporate structural features including spacer blocks and tube stops to ensure proper alignment between the tube and the ultrasonic sensor, maintaining a precise measurement distance.

At 408, sampling by the portable ultrasonic measurement system is initiated, either automatically upon proper positioning or through operator input. Such sampling can include the transmission of ultrasonic signals, typically at 40-50 kHz, from the ultrasonic sensor towards the surface of the water within the water level tube. Multiple measurements can be taken in rapid succession to ensure accuracy.

At 410, the water level within the water level tube is measured through Time of Flight (ToF) calculations. In some embodiments, the system can account for environmental factors such as temperature and humidity that affect sound wave propagation speed. Multiple readings can be averaged to produce a final measurement, with outlier rejection to enhance accuracy.

At 412, GPS coordinates of the portable ultrasonic measurement system at the time of the measurement are obtained from satellite signals and stored with the water level data. Additional metadata including, without limitation, timestamp, temperature, and battery status can also be recorded.

At 414, an attempt to connect to the server can be made using available wireless communication protocols (cellular, Wi-Fi, or Bluetooth). At 416, it is determined if network connectivity meets minimum signal strength and stability requirements. If no network connectivity is available, the water level data, GPS coordinates, and any associated metadata can be stored locally in non-volatile memory at 420 for later transmission.

If network connectivity is available, at 418, the water level data package is transmitted to the server using communication protocols. The system can verify successful data transmission through acknowledgment from the server. At 422, the process ends, with the system either powering down or remaining ready for additional measurements based on configuration settings.

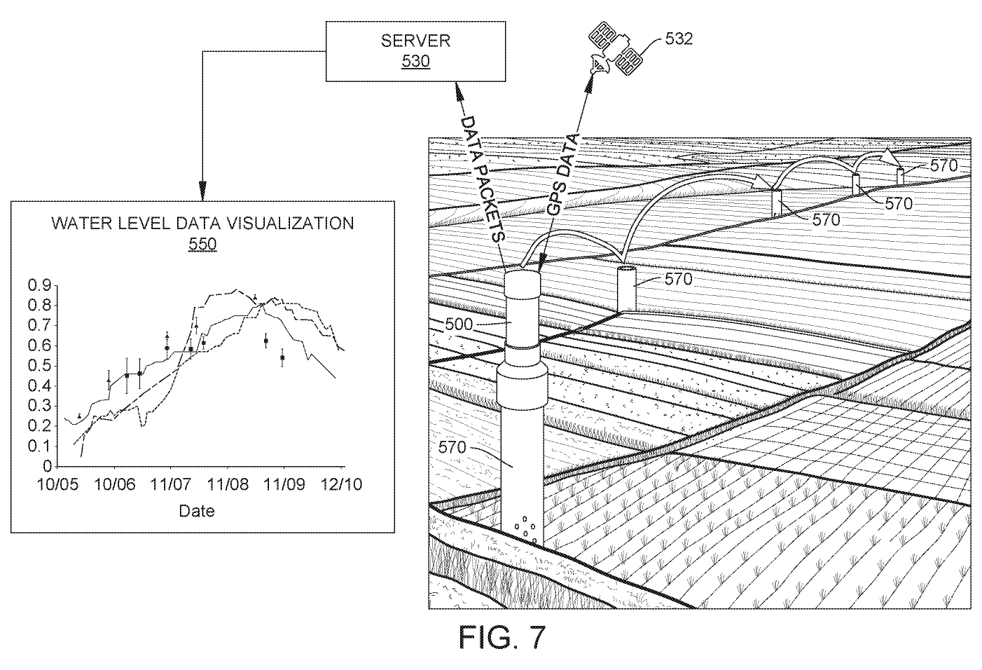

Referring now to FIG. 7, an example use of a portable ultrasonic measurement system 500 in the field is schematically depicted. As shown, a plurality of water level tubes 570 are positioned throughout rice paddies. In some embodiments, the tubes 570 are spaced according to recommended spacing guidelines for Alternate Wetting and Drying (AWD) practices, typically one tube per 0.25-0.5 hectares of paddy field.

The portable ultrasonic measurement system 500 can be sequentially placed on top of each of the water level tubes 570 by an operator to capture water level data during monitoring rounds. The water level data can be automatically associated with its geographic location using signals from a GPS system 532, which can provide coordinates for spatial mapping purposes.

As shown, this geo-tagged water level data can be transmitted to a server 530 through cellular or wireless networks. The server 530 can process the data to provide water level visualization 550 through web-based dashboards or mobile applications, for example. These visualizations can include color-coded field maps showing water depth variations, temporal trends of water levels, and automated alerts when measurements fall outside predetermined thresholds.

The server 530 can also generate other relevant metrics or information based on the collected water level data, such as irrigation scheduling recommendations, water savings calculations compared to conventional flooding practices, and estimated greenhouse gas emission reductions through AWD implementation. This data can be integrated with other agricultural management systems to provide comprehensive field monitoring and decision support capabilities for optimal water management in rice cultivation.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described to best illustrate principles of various embodiments as are suited to particular uses contemplated. The scope is, of course, not limited to the examples set forth herein, but can be employed in any number of applications and equivalent devices by those of ordinary skill in the art.

1. A portable ultrasonic measurement system for measuring water levels, comprising:
a body housing a controller, data storage, and a power source;
a coupling portion extending from the body, the coupling portion defining a cavity configured to receive a top portion of a water level tube;
an ultrasonic sensor coupled to the coupling portion, the ultrasonic sensor configured to transmit ultrasonic signals toward a water surface within the water level tube and receive reflected signals from the water surface; and
a GPS module configured to obtain geographic coordinates associated with water level measurements,
wherein the controller is configured to calculate a water level within the water level tube based on a time of flight of the ultrasonic signals and the reflected signals.

2. The portable ultrasonic measurement system of claim 1, wherein the coupling portion comprises a rigid wall fabricated from weatherproof material.

3. The portable ultrasonic measurement system of claim 2, wherein the coupling portion further comprises a plurality of spacer blocks coupled to an inner surface of the rigid wall, the spacer blocks configured to center the water level tube within the cavity.

4. The portable ultrasonic measurement system of claim 3, wherein the coupling portion further comprises a plurality of tube stops extending from the inner surface of the rigid wall, the tube stops configured to engage with a top surface of the water level tube to provide a known distance between the top of the water level tube and the ultrasonic sensor.

5. The portable ultrasonic measurement system of claim 1, further comprising a network interface configured to wirelessly transmit water level measurements to a remote server.

6. The portable ultrasonic measurement system of claim 5, wherein the network interface comprises at least one of cellular connectivity, Wi-Fi connectivity, or Bluetooth connectivity.

7. The portable ultrasonic measurement system of claim 1, wherein the controller is further configured to associate a timestamp with each water level measurement.

8. The portable ultrasonic measurement system of claim 7, wherein the controller is further configured to store the water level measurements, timestamps, and geographic coordinates in the data storage.

9. The portable ultrasonic measurement system of claim 1, further comprising at least one output indicator configured to convey operational status to an operator.

10. The portable ultrasonic measurement system of claim 9, wherein the at least one output indicator comprises at least one of a power status indicator, a network status indicator, or a sampling status indicator.

11. The portable ultrasonic measurement system of claim 1, further comprising an input device configured to initiate a water level measurement process.

12. A method for measuring water levels, comprising:
positioning a portable ultrasonic measurement system on a top portion of a water level tube, the water level tube being at least partially inserted into soil and at least partially filled with water;
transmitting, by an ultrasonic sensor of the portable ultrasonic measurement system, ultrasonic signals toward a water surface within the water level tube;
receiving, by the ultrasonic sensor, reflected signals from the water surface;
calculating, by a controller of the portable ultrasonic measurement system, a water level within the water level tube based on a time of flight of the ultrasonic signals and the reflected signals; and
obtaining, by a GPS module of the portable ultrasonic measurement system, geographic coordinates associated with the water level measurement.

13. The method of claim 12, further comprising associating a timestamp with the water level measurement.

14. The method of claim 13, further comprising storing the water level measurement, the timestamp, and the geographic coordinates in data storage of the portable ultrasonic measurement system.

15. The method of claim 14, further comprising:
attempting to connect to a remote server;
determining whether network connectivity is available; and
transmitting the water level measurement, the timestamp, and the geographic coordinates to the remote server when network connectivity is available.

16. The method of claim 15, wherein the water level measurement, the timestamp, and the geographic coordinates are stored in the data storage when network connectivity is not available.

17. A portable ultrasonic measurement system, comprising:
a body comprising a weatherproof enclosure housing a controller, data storage, a power source, and a network interface;
a coupling portion extending from the body, the coupling portion comprising:
a rigid wall defining a cavity configured to receive a top portion of a water level tube;
a plurality of spacer blocks coupled to an inner surface of the rigid wall and configured to center the water level tube within the cavity; and
a plurality of tube stops extending from the inner surface and configured to engage a top surface of the water level tube to provide a known distance between the top of the water level tube and an ultrasonic sensor;
the ultrasonic sensor coupled to a top wall of the coupling portion, the ultrasonic sensor configured to transmit ultrasonic signals and receive reflected signals from a water surface within the water level tube; and
a GPS module configured to obtain geographic coordinates,
wherein the controller is configured to calculate a water level based on a time of flight of the ultrasonic signals and the reflected signals and to associate the geographic coordinates with the calculated water level.

18. The portable ultrasonic measurement system of claim 17, wherein the network interface comprises at least one of cellular connectivity, Wi-Fi connectivity, or Bluetooth connectivity for wirelessly transmitting the calculated water level and the associated geographic coordinates to a remote server.

19. The portable ultrasonic measurement system of claim 18, wherein the controller is further configured to store the calculated water level and the associated geographic coordinates in the data storage when network connectivity is unavailable.

20. The portable ultrasonic measurement system of claim 17, further comprising at least one output indicator configured to convey at least one of a power status, a network status, or a sampling status to an operator.
